(19) United States
(12) Patent Application Publication
(10) Pub. No.: US 2008/0149418 A1
(43) Pub. Date: Jun. 26, 2008

(54) Speaker system

(75) Inventors: Satoshi Imamura, Gunma-ken (JP); Junji Iino, Gunma-ken (JP); Shinji Kamimura, Gunma-ken (JP)

Correspondence Address: NATH & ASSOCIATES, 112 South West Street, Alexandria, VA, 22314, US

(73) Assignee: VICTOR COMPANY OF JAPAN, LIMITED, Yokohama-shi (JP)

(21) Appl. No.: 12/000,484

(22) Filed: Dec. 13, 2007

(30) Foreign Application Priority Data
Dec. 21, 2006 (JP) P2006-343721

(51) Int. Cl. G10K 11/162

(52) U.S. Cl. 181/199

(57) ABSTRACT

A speaker system includes a speaker cabinet having a unit mounting port; a speaker unit attached to the unit mounting port; a sound absorbing structure disposed at a rear portion side of the speaker unit and in the speaker cabinet. The sound absorbing structure includes a porous air-permeable bag and flaky wood chips provided in the bag.

### CROSS REFERENCE TO RELATED APPLICATIONS

This application is based upon and claims the benefit of priority from the prior Japanese Patent Application No. P2006-343721, filed on Dec. 21, 2006 the entire content of which is incorporated herein by reference.

### BACKGROUND OF THE INVENTION

1. Field of the Invention

The present invention relates to a speaker system which converts an electrical signal into an acoustical signal (acoustic energy). More particularly, the invention relates to an acoustical speaker system which suppresses generation of a standing wave inside a speaker cabinet for obtaining a flat reproduction frequency that has small in peaks/dips.

2. Description of the Related Art

A speaker system is provided with a speaker unit and a cabinet (enclosure). The speaker unit can be classified as a full range, a tweeter, a midrange, and a woofer depending on a sound reproduction band. As for the cabinet to which the speaker unit is attached, a rear open type and a closed type are known, and the type is selected depending on its manner of use.

The foregoing speaker cabinet basically uses a baffle plate (front surface plate) having a unit mounting port to which the speaker cabinet is attached and has top, bottom, left and right plate-shaped portions, which are bent behind the mounting plate. Thus, a standing wave is generated inside the cabinet when the speaker unit is driven. Hence, there is a difficulty that a sharp peak/dip is increased in the reproduction frequency.

For this reason, in above-described kind of speaker cabinet, typically, a sound absorbing material is arranged therein, in order to suppress generation of the standing wave.

As the sound absorbing material, glass wool, rock wool, coarse hair wool, coarse hair felt, acetate cotton, or flexible porous curl rock (a registered trademark) produced from a plastic bottle may be used. However, none of the above materials are cheap because many steps are required in their manufactured, and disposal of such materials is not easy. Also, there is a case in which the attenuation effect of a sound wave does not meet expectations. Some little sound waves input into the cabinet may leak outside of the cabinet, and the leaked wave(s) interferes with the sound wave emitted from the front of the unit. In such a case the lively feeling of the reproduction sound is lost and the reproduced sound quality is deteriorated.

There is a case in which a perforated plate or a sound absorbing member (an acoustic pipe) is installed inside the cabinet. However, the perforated plate has a low in sound absorption rate and is effective only for a particular frequency. Thus, this structure is not effective, resonates with the particular frequency in the sound absorbing member (the acoustic pipe), and emphasizes the sound. Hence, sound reproduced by such a unit is unnatural sound reverberations.

In addition, as the sound absorbing material, a rigid resin short tube made of polypropylene and the like can be used. A bag is filled with the rigid resin short tubes and is used as a pillow. A known speaker unit is packed with and surrounded by the pillow (for example, refer to Japanese Unexamined Patent Application Laid-Open (Koukai) No. 2002-281579 (hereinafter referred to as “document 1”)).

However, the sound absorbing material made of the rigid resin short tube is not cheap, and a high processing cost is required for the disposal process.

Also, in the document 1, the speaker unit is accommodated inside the sound absorbing material. Thus, not only the sound wave, but also most high band sounds transmitted to a listener, are attenuated. Also, the sound absorbing material resonates with the sound wave of the particular frequency emitted from the front of the unit. Then, such a resonance is propagated as noise to the listener. Hence, high quality sound reproduction cannot be obtained by the device disclosed in document 1.

### SUMMARY OF THE INVENTION

The present invention provides a speaker system that uses a sound absorbing material. The sound absorbing material is cheap in cost, high in sound absorption effect, easily disposables, and can achieve high quality sound reproduction with a flat reproduction frequency.

An aspect of the present invention inheres in a speaker system encompassing a speaker cabinet having a unit mounting port; a speaker unit attached to the unit mounting port; a sound absorbing structure disposed in a rear portion of the speaker unit and within the speaker cabinet, the sound absorbing material including a porous air-permeable bag and thinly flaked wood chips provided in the bag.

According to the speaker system based on the present invention, the wood chips are shaped as thin pieces and is used as the sound absorbing material. Thus, the cost of the sound absorbing material is decreased. Disposal of the sound absorbing material is not complicated. The environment is not contaminated. Moreover, the wood residue can be used as fuel or raw compost material or re-used as the sound absorbing material.

Also, the wood chips in the shape of thin piece have a high sound absorption effect. When the wood chips are arranged inside the speaker cabinet, the generation of a standing wave can be suppressed, so as to obtain a flat reproduction frequency that does not have sharp peaks and dips and can improve the quality of the reproduced sound.

Moreover, since the thin wood chips are provided in a porous, air-permeable bag, the wood chips are not scattered, and the arrangement thereof in the speaker cabinet can be easily performed. Thus, the manufacturing process can be greatly improved as compared to the case where the glass wool and the like are stuck on the inner wall of the cabinet. In particular, the sound absorbing structure in which the wood chips are provided in a bag can always be properly provided inside various shaped cabinets, depending on various deformations of the cabinet.

In addition, wood chip material that has been shaved from other wood material and curled during the shaving process can be used as the wooden chips, particularly, wood chip shavings between 0.05 mm and 1 mm can be used. Thus, wood shavings that have previously been burned and disposed can now be effectively used as the sound absorbing material. Moreover, obtaining such wood chips is easy, and frequency properties similar to a conventional speaker can be achieved. Also, the feeling of live music is extremely improved over the conventional speaker, and the reproduction of high quality, faithful sound reproduction can be achieved.

### BRIEF DESCRIPTION OF THE DRAWINGS

FIG. 1 is a cross-sectional view illustrating an example of a speaker system according to an embodiment of the present invention;

FIG. 2 is a perspective view illustrating a sound absorbing structure according to the embodiment of the present invention;

FIG. 3 is a view (a picture) showing an example of a wood chip according to the embodiment of the present invention;

FIG. 4 is a graph showing a frequency property of the speaker system according to the embodiment of the present invention;

FIG. 5 is a graph showing the frequency property of the speaker system in which the sound absorbing structure according to the embodiment is not arranged inside a cabinet; and

FIG. 6 is a graph showing the frequency property of the speaker system in which a coarse hair felt is arranged inside the cabinet, instead of the sound absorbing structure according to the present invention.

### DETAILED DESCRIPTION OF THE INVENTION

An embodiment of the present invention will be described with reference to the accompanying drawings. In the following descriptions, numerous details are set forth such as specific signal values, etc. to provide a thorough understanding of the present invention. However, it will be obvious to those skilled in the art that the present invention may be practiced without such specific details.

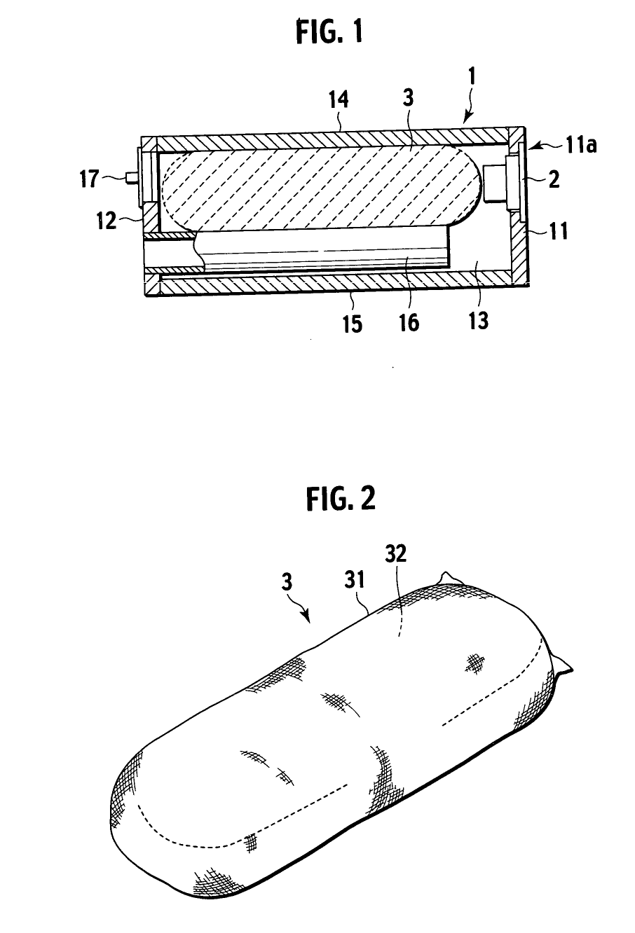

A speaker system according to an embodiment of the present invention includes speaker cabinet (enclosure), a speaker unit 2, and a sound absorbing structure 3. In the present embodiment, for example, the speaker cabinet 1 is in the shape of a rectangular hollow body which is laterally long and made from a wood plate or the like. The speaker cabinet 1 has a front surface portion 11 (baffle plate), a rear portion 12 opposite the front surface portion 11, a pair of left and right sides 13 connected to the front surface portion 11 and the rear portion 12, a top surface portion 14 and a bottom surface portion 15. The speaker cabinet 1 of FIG. 1 is a phase inversion type cabinet in which a duct 16 continuous from outside the speaker cabinet to inside the speaker cabinet 1 is attached to the rear portion 12. A terminal 17 that is electrically connected to an amplifier (not shown) is attached to the rear portion 12.

The speaker cabinet 1 is not limited to the phase inversion type (the duct 16 can be attached to the front surface portion 11). With a front attachment structure, the speaker cabinet 1 is a closed type in which the duct 16 is omitted or may be a rear open type in which the rear portion 12 is omitted. Also, the shape of the speaker cabinet is not limited to the rectangular parallelepiped type (box type) and may be oval or a sectional ellipse or the like.

A circular unit mounting port 11a is formed on the front surface portion 11 of the speaker cabinet 1 so as to protrude therefrom. The speaker unit 2 is attached to the unit mounting port 11a so that a sound transmission surface is oriented to the outside of the cabinet. Then, the speaker unit 2 and the terminal 17 are electrically connected through a signal line (not shown) laid inside the speaker cabinet 1. Here, the present embodiment of the speaker unit 2 is the full range type, and configures a one-way speaker system structure. However, a tweeter, a midrange, and a woofer and the like may be used in the speaker unit 2, and a 2 to 5 way speaker system structure may be designed.

Also, as shown in FIG. 1, the sound absorbing structure 3 is in an amorphous form and arranged inside the speaker cabinet 1. The sound absorbing structure 3 is stuffed inside the speaker cabinet 1 so as to cover the rear surface side of the speaker unit 2.

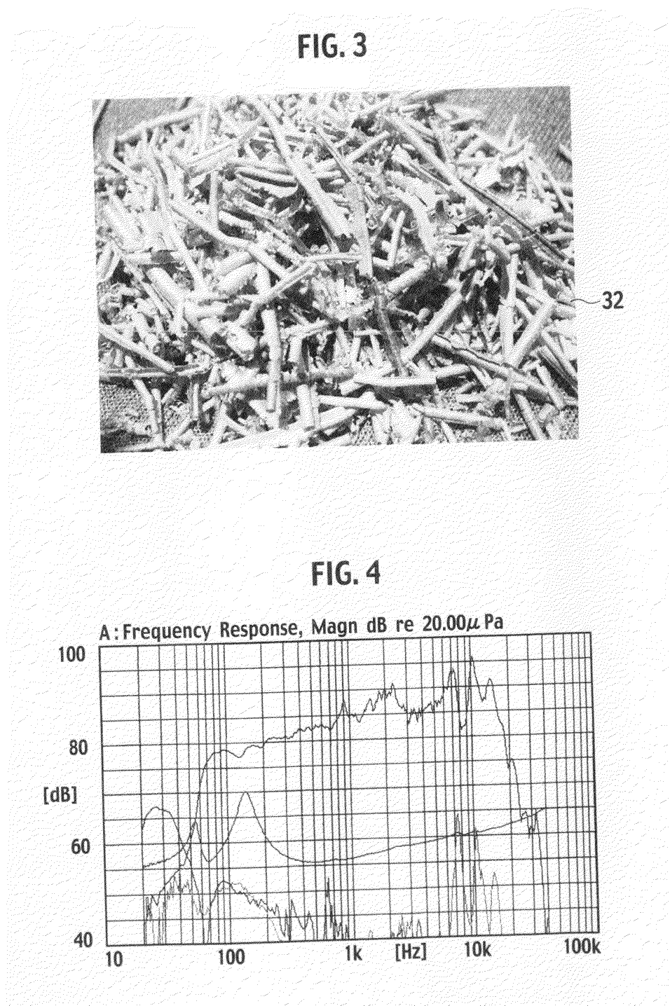

As shown in FIG. 2, the sound absorbing structure 3 includes a bag 31 that is air-permeable, deformable and porous, and thin wood chips 32 are filled in the bag 31. An example of the wood chips 32 in the bag 31 is shown in FIG. 3.

The bag 31 is made from a coarse net-shaped mesh fabric, which is made of natural fiber such as cotton, cannabis or the like, or chemical fiber such as polyester, nylon or the like. Its net structure is defined as being between 0.1×0.1 and 3×3 mm (between 3 and 100 meshes). However, the bag 31 is not limited to a coarsely-net textile or knit fabric. It is possible to use a non-woven thin-net fabric and has less air-flow resistance than the above-described materials. In short, the bag 31 may be a material that is deformable, porous and air-permeable and can protect the inner wood chips 32 from spilling out of the bag.

The wood chips 32 are configured as flexible thin piece, which can be used irrespective of the material quality. However, a rigid material that provides a higher sound propagation speed and a higher internal loss (sound absorption rate) than the flexible material, such as paulownia, may be used. For example, cherry, birch, beech, oak, linden, spruce and the like can be preferably used. In addition, the propagation speeds of such wood material are between 4 km/sec and 5 km/sec (the grain direction), and internal losses (tan) of such materials are between 0.01 and 0.03.

In the present embodiment, wood shavings having a thickness in the range of 0.05 mm and 1 mm are used as the wood chips 32. However, wood shavings having a half-cylindrical or cylindrically curled shape, as shown in FIG. 3, which are lower in bulk density and larger in surface area than chips in the shape of a band or which have a flat surface, are suitable.

In particular, the wood chips 32 are bulky, and the bulk density is preferably between 0.05 g/cm³ and 0.3 g/cm³. Accordingly, the repulsive force of the in-cabinet air that is generated against the compression of the speaker unit 2 is weakened, so that the speaker unit 2 can be smoothly driven.

The small, thin wood chips 32 are curled as shown in FIG. 3 (as for individual size, the curl diameter is in a range of between about 3 mm and about 5 mm, and the length is in a range of between about 10 mm and about 30 mm). The chips 32 are produced in large quantity when wood is planed by an electric plane (including a plane base). Thus, the chips can be easily obtained and reserved at an extremely low cost (substantially at shipping cost).

In addition, when the speaker cabinet 1 is wood, neither the cabinet nor the wooden chip may be the same kind of woods. However, since wood shavings generated from manufacturing the speaker cabinet 1 can be used as the wood chips 32, it may be preferable that the speaker cabinet 1 and the wood chips 32 are from the same kind of woods.

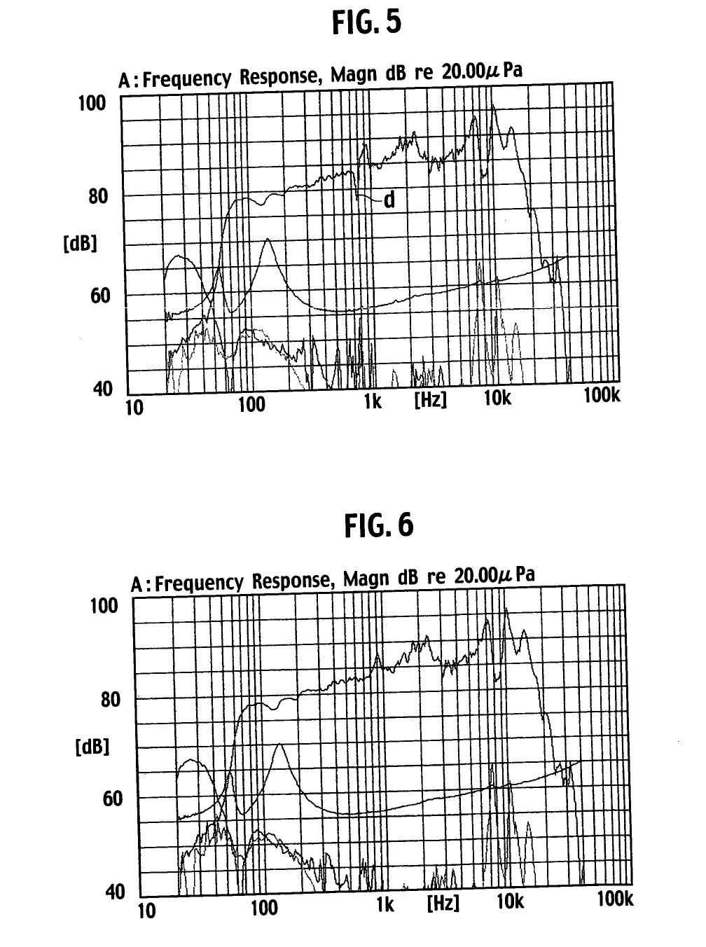

FIG. 4 is a graph showing a frequency property of the speaker system according to the present invention. FIG. 5 shows a frequency property of the speaker system in which the sound absorbing structure 3 of the present invention is omitted, as a comparison example. FIG. 6 shows a frequency property of the speaker system (a conventional example) in which coarse hair felt is arranged inside the cabinet, instead of the sound absorbing structure 3 according to the present invention. For the speaker unit and the cabinet, the same materials are used. Also, in the speaker system according to the present embodiment, a mesh bag (Saran net of 60 mesh) made of polyester is used for the bag 31, and the wood shavings (having a thickness of about 0.1 mm) in the shape shown in FIG. 3 that is generated from cherry wood is used for the wood chips 32. Such wood shavings of about 30 grams are stuffed into the bag 31, and an opening in the bag is closed, thereby forming the sound absorbing structure 3 (the apparent volume of the wood chips 32 is about 300 cm³).

When the speaker system according to the present invention and the speaker system without any sound absorbing material are compared in accordance with FIG. 4 and FIG. 5, it is seen that in the FIG. 5, a dip d (a valley of medium tones) in which sound pressure level is severely attenuated near a frequency of 800 Hz is generated. On the other hand, in FIG. 4, the generation of the valley of the medium tones is suppressed. This indicates that the sound absorbing structure 3 suppresses the standing wave inside the speaker unit 2.

As can be understood from FIG. 6, it is known that the generation of the valley of medium sounds can be suppressed with regard to the frequency, even in the typical conventional speaker system that uses coarse hair felt as the sound absorbing material. However, it is evident that the speaker system of the present invention in which the sound absorbing structure 3 is provided as wood chips is excellent with regard to providing a live sound performance feeling. Specifically, the speaker system of the present invention provides the live performance feeling in the reproduction of sound, as compared with a system that uses the conventional sound absorbing material, and the resolution of the low band in the present invention is especially clear, as is the separation of the individual instrument sounds.

According to the embodiment of the present invention, it is possible to obtain an excellent effect in which wood chips that are cheap and easily disposed are used. In addition, frequency properties similar to the conventional speaker can be used, and also an audition (live sound) feeling is extremely improved over the conventional speaker, and the reproduction of the high-quality, accurate sound can be achieved.

What is claimed is:

1. A speaker system comprising:
a speaker cabinet having a unit mounting port;
a speaker unit attached to the unit mounting port;
a sound absorbing structure disposed in a rear portion of the speaker unit and within the speaker cabinet, the sound absorbing material including a porous air-permeable bag and thinly flaked wood chips provided in the bag.

2. The speaker system according to claim 1, wherein the wood chips are curled and have a thickness in the range of 0.05 mm to 1 mm.

3. The speaker system according to claim 2, wherein the wood chips are wood shavings sliced from a type of wood.

4. The speaker system according to claim 1, wherein the speaker cabinet is wood, and the wood chips are the same kind of wood as the speaker cabinet.
